(19) United States
(12) Patent Application Publication
(10) Pub. No.: US 2002/0035727 A1
(43) Pub. Date: Mar. 21, 2002

(54) Program guide display apparatus and program guide display method

(75) Inventors: Masahiro Numata, Tokyo-to (JP); Tatsu Inoue, Tokyo-to (JP); Kazuhiro Watanabe, Tokyo-to (JP)

Correspondence Address: SUGHRUE, MION, ZINN, MACPEAK & SEAS, 2100 Pennsylvania Avenue, N.W., Washington, DC, 20037, US

(73) Assignee: PIONEER CORPORATION

(21) Appl. No.: 09/955,173

(22) Filed: Sep. 19, 2001

(30) Foreign Application Priority Data
Sep. 19, 2000 (JP) P2000-283208

(51) Int. Cl. G06F 3/00; H04N 5/445; G06F 13/00

(52) U.S. Cl. 725/44

(57) ABSTRACT

A program guide apparatus in which a user can easily look for a desired program on an EPG display screen are provided. On the basis of a priority degree calculated for each program, program cells of programs are arranged and displayed on a program guide display screen of a predetermined time range. Therefore, a user can easily find out a desired program on the program guide display screen.

### BACKGROUND OF THE INVENTION

1. Field of the Invention

The present invention relates to an electronic program guide (EPG).

2. Description of the Related Art

In recent years, a digital broadcasting system, in which digitalized television signals are transmitted via a satellite such as a broadcasting satellite or a communication satellite and they are received at each home to view a television program, is in service. In this kind system, since many channels can be secured, a very large number of programs can be broadcasted.

In such a system, information on an electronic program guide (EPG) indicating broadcasting contents of many programs is transmitted to the receiver in each home together with video/audio information of programs. A user operates the receiver to display the electronic program guide on the TV display and looks for a program to be viewed. Generally in the display of the electronic program guide, the user can use a remote controller attached to the receiver to look for a desired program and select it.

However, since the number of programs provided by EPG is very large as 100 or more, the number of programs displayable in one EPG display screen is limited.

Therefore, to look for a desired program on the EPG display screen using a remote controller or the like, the user must change the screen many times. This requires much time and labor.

### SUMMARY OF THE INVENTION

The present invention has made on the above viewpoint and aims to provide a program guide apparatus and a program guide method in which a user can easily search a desired program on an EPG display screen.

The above object of the present invention can be achieved by a program guide apparatus of the present invention for displaying information about a broadcast program on a program guide display. The apparatus is provided with: a priority degree calculating device for calculating priority degrees of programs; and a display device for, on the basis of the calculated priority degrees of said programs, arranging and displaying program cells of the programs on a program guide display screen of a predetermined time range.

According to the present invention, on the basis of a priority degree calculated for each program, program cells of programs are arranged and displayed on a program guide display screen of a predetermined time range. Therefore, a user can easily look for a desired program on the program guide display screen.

The above object of the present invention can be achieved by a program guide apparatus of the present invention for displaying information about a broadcast program on a program guide display. The apparatus is provided with: a priority degree calculating device for calculating priority degrees of programs; and a display device for, in the order of the calculated priority degrees, arranging and displaying program cells of the programs on a program guide display screen of a predetermined time range.

According to the present invention, in the order of programs in which a priority degree calculated for each program is higher, that is, so that the program whose priority degree is higher should be preferentially treated, and then program cells of programs are arranged and displayed on a program guide display screen of a predetermined time range. Therefore, a user can easily look for a desired program on the program guide display screen.

In one aspect of the present invention, said display device displays visibly said programs which overlap one another in time.

According to this aspect, even in case that there is overlapping in time between programs displayed based on the priority degrees, it can easily be confirmed.

In another aspect of the present invention, the apparatus is further provided with a list display device for displaying a list of programs which overlap a program cell selected by a user in time.

According to this aspect, for example, even for a program that is not displayed on the program guide display screen because of its low priority, information on the program can easily be confirmed by a list.

In further aspect of the present invention, said display device displays a classification axis, which is provided in a different direction from a time axis in said program guide display screen, and by each classification in said classification axis, arranges and displays said program cells on the program guide display screen of the predetermined time range.

According to this aspect, the program cells displayed based on the priority degrees can be displayed by classification.

In further aspect of the present invention, said priority degree calculating device calculates the priority degrees of said programs on the basis of a predetermined operation history of a user.

According to this aspect, since the priority degrees of the programs are calculated on the basis of a predetermined operation history of a user, a program guide peculiar to the user can be displayed.

In further aspect of the present invention, said priority degree calculating device calculates the priority degrees of said programs on the basis of at least one or a combination of a view history, a recording history, a view reservation history, a recording reservation history, a detailed information utilization history, and a user's favorites registration history of a user.

According to this aspect. since the priority degrees of the programs are calculated on the basis of at least one or a combination of a view history, a recording history, a view reservation history, a recording reservation history, a detailed information utilization history, and a user's favorites registration history of a user, a program guide desired by the user can be displayed.

In further aspect of the present invention, said display device determines the program cells to be arranged and displayed on said program guide display screen on the basis of a relative relation among the priority degrees of a plurality of programs.

According to this aspect, for example, of programs whose time zones overlap. the cell of a relatively higher-priority program can be displayed.

In further aspect of the present invention, said display device determines the program cells to be arranged and displayed on said program guide display screen on the basis of a relation with a reference priority degree provided in advance.

Therefore, for example, of programs whose time zones overlap. even in case of a relatively higher-priority program, in case that it is lower than a reference priority degree. the cell of the program is possible not to be displayed.

In further aspect of the present invention, said reference priority degree can be arbitrarily set.

According to this aspect, the program cells displayed based on the priority degrees can be displayed per genre of program.

In further aspect of the present invention, said classification is a genre of program.

According to this aspect the program cells displayed based on the priority degrees can be displayed per broadcasting medium of program.

In further aspect of the present invention, said classification is broadcasting medium of said programs.

According to this aspect. on one screen, program lists peculiar to a plurality of users can be displayed.

The above object of the present invention can be achieved by a program guide method of the present invention of displaying information about a broadcast program on a program guide display. The method is provided with the processes of: calculating priority degrees of programs; and arranging and displaying program cells of the programs on the program guide display screen of a predetermined time range wherein the program whose priority degree is higher should be preferentially displayed.

According to the present invention, a user can easily look for a desired program on a program guide display screen.

### BRIEF DESCRIPTION OF THE DRAWINGS

FIG. 1 is a block diagram showing the construction of a satellite digital broadcasting receiver according to an embodiment of the present invention;

FIG. 2 shows an example of contents of history by program;

FIGS. 3A and 3B show examples of contents of history by genre and history by series, respectively;

FIG. 4 shows point data used in calculation of priority degree;

FIG. 5 shows a data transmission method by digital broadcasting;

FIG. 6 shows an example of basic EPG display screen;

FIG. 7 shows an example of priority EPG display screen by medium;

FIG. 8 shows an example of priority EPG display screen by genre;

FIG. 9 shows an example of an EPG display screen in priority order;

FIG. 10 is a view showing an appearance of a remote controller used in association with the receiver of FIG. 1;

FIG. 11 is a flowchart of priority EPG display processing by medium;

FIG. 12 is a flowchart of calculation processing of priority degree;

FIG. 13 is a flowchart of display processing of EPG in priority order;

FIG. 14 is a flowchart of display processing of priority EPG by genre:

FIG. 15 shows an example of display screen of priority EPG by user: and

FIG. 16 shows an example of contents of history by user and by program.

### DETAILED DESCRIPTION OF THE PREFERRED EMBODIMENT

Hereinafter, a preferred embodiment of the present invention will be described with reference to the accompanying drawings.

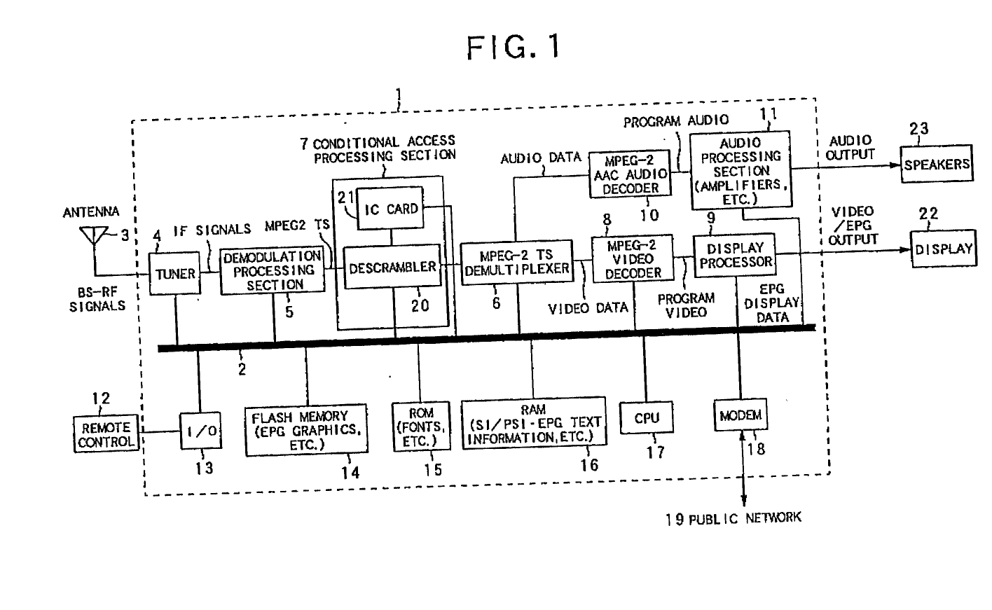

FIG. 1 shows the construction of a satellite digital broadcasting receiver according to an embodiment of the present invention. The satellite digital broadcasting receiver 1 shown in FIG. 1 is disposed in a viewer's home, receives digital broadcasting signals (broadcasting wave) from a satellite, and displays a program on a display 22 of the receiver 1. Besides, it has a function for receiving information on an electronic program guide (EPG) simultaneously sent from the satellite and displaying it on the display 22 in accordance with viewer's instructions.

As shown in FIG. 1, the receiver 1 has a construction in which various components are connected to a bus 2. Besides. the receiver 1 can be operated with a remote controller 12 accessory to the receiver 1.

A broadcasting wave (BS-RF signal) transmitted from the satellite is received by an antenna 3 and sent to a tuner 4 in the receiver 1. This broadcasting wave contains service information (SI) to be used for displaying EPG, in addition to video/audio information for programs (hereinafter referred to as program information). The tuner 4 tunes in a reception band selected by a user, converts the received signal wave into an intermediate frequency (IF) signal, and send it to a demodulation processing section 5. The demodulation processing section 5 demodulates the input digital signal, performs necessary processes for, e.g., reconstruction of data frame and error correction, and supplies data in the form of transport stream (TS) of MPEG 2 to a demultiplexer 6 through a descrambler 20.

The demultiplexer 6 extracts audio data and video data of a designated service from inputted TS of MPEG 2, and supplies them to an audio decoder 10 and a video decoder 8, respectively. The audio data is in the form of MPEG 2-AAC and the video data is in the form of MPEG 2-Video. The audio decoder 10 decodes the inputted audio data to generate program audio data, and supplies the program audio data to an audio processing section 11. The audio processing section 11 includes an amplifier and performs predetermined audio signal processing to generate an audio output.

On the other hand, the video decoder 8 decodes the video data to generate program video data. and supplies the program video data to a display processor 9. The display processor 9 applies predetermined processing to the inputted program video data and thereby generates a video output. Besides, the display processor 9 has a function for superimposing character information or the like on a program video image displayed on the display 22. EPG display data, which will be described later, is superimposed on the program video data by the display processor 9, or is outputted in place of the program video data and displayed on the display 22.

Besides. the demultiplexer 6 extracts data including SI (data other than program information) from the inputted TS of MPEG 2. SI is information as the origin of EPG display data and EPG display processing is performed using SI. The data such as SI extracted by the demultiplexer 6 is stored in a RAM 16 under the control of a CPU 17. Besides, EPG text data for displaying EPG is stored in the RAM 16.

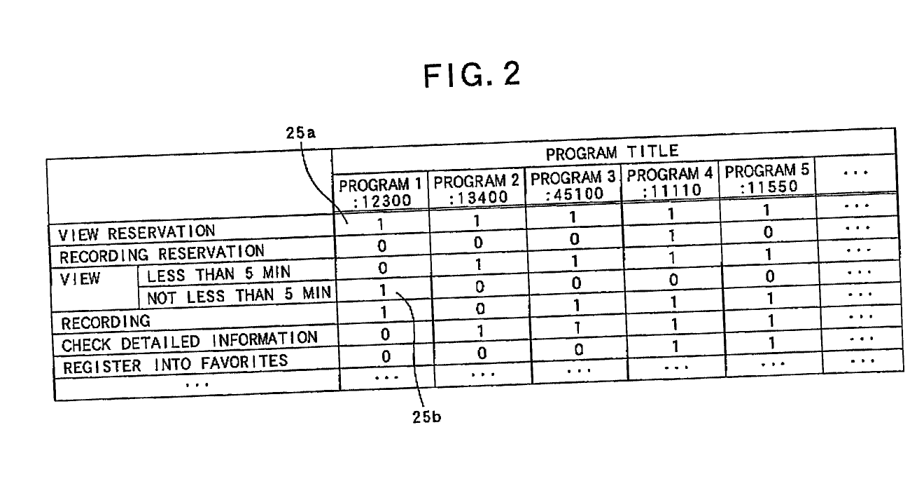

Besides, the RAM 16 stores therein a user's operation history by program (hereinafter referred to as history by program). FIG. 2 shows an example of history by program stored in the RAM 16. As shown in FIG. 2, user operation items include “view reservation”, “recording reservation”, “view”, “recording”, “detailed information check”, “registration into favorites”, and so on. In history by program of FIG. 2, the histories of those items are managed. These histories are stored so as to correspond to the respective programs. In the example of FIG. 2, they are indicated by “1” or “0” in each column of program title (program 1, program 2, . . . ). The numerals below each program title shown in FIG. 2 indicates an identification code peculiar to the program. In the embodiment, “1” in each item (corresponding to a memory area) of FIG. 2 means that the operation corresponding to the item was performed, while “0” means that the operation corresponding to the item was not performed. For example, since the item corresponding to “view reservation” of the program 1 (denoted by 25a) is indicated by “1”, this means that a view reservation was made for the program 1. Besides, “view” shown in FIG. 2 is divided into “less than five minutes” and “not less than five minutes”. For example, since the item corresponding to “view not less than five minutes” of the program 1 (denoted by 25b) is indicated by “1”, this means that the program 1 was actually viewed for five or more minutes. Besides, “detailed information check” indicates whether or not the user checked detailed information on the program, and “registration into favorites” indicates whether or not the user registered the program into favorites.

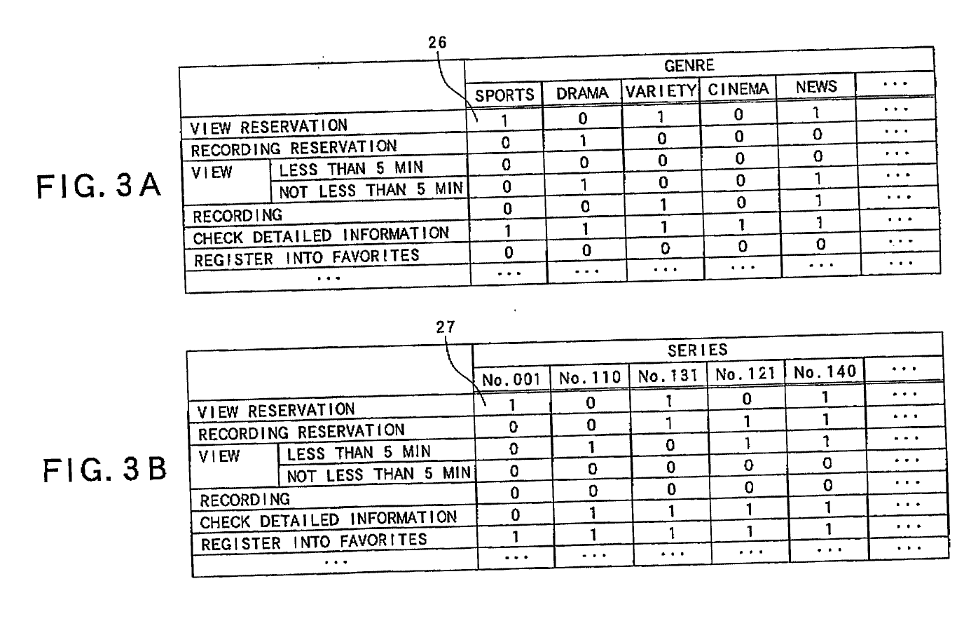

Further, the RAM 16 stores therein a user's operation history by genre (hereinafter referred to as history by genre). FIG. 3A shows an example of history by genre stored in the RAM 16. In the embodiment, “genre” is information indicating kinds of programs, wherein there are kinds of, e.g., “sports”, “drama”, “cinema”. “variety”, “news”, etc. A genre has been set for each program. This information on genre is contained in SI. Also in history by genre, as shown in FIG. 3A, like history by program, user operation items include “view reservation”, “recording reservation”, “view”, “recording”, “detailed information check”, “registration into favorites”, and so on. For example, when the user made a view reservation for a program whose genre is “sports”, “1” is stored in the item corresponding to “view reservation” of “sports” (denoted by 26) as shown in FIG. 3A.

Besides, the RAM 16 stores therein a user's operation history by series (hereinafter referred to as history by series). FIG. 3B shows an example of history by series stored in the RAM 16. Certain programs are provided as a series. For example, programs of the same title broadcasted every day or every week are provided as a series, such as a series drama. The programs in the same series are denoted by the same series number. This information on series number is also contained in SI. Also in history by series, as shown in FIG. 3B, like history by program, user operation items include “view reservation”, “recording reservation”, “view”, “recording”, “detailed information check”, “registration into favorites”, and so on. For example, when the user made a view reservation for the program of series number 001, “1” is stored in the item corresponding to “view reservation” of No. 001 (denoted by 27) as shown in FIG. 3B. Note that the user's operation history is not limited to “view reservation”, “recording reservation”, “view”, “recording”, “detailed information check”, and “registration into favorites”, and it may includes any other user's operation history than those. Besides, a nonvolatile RAM or the like can be used as the RAM 16.

A flash memory 14 stores therein various graphic data necessary for displaying EPG (the frame of the program guide, predetermined marks such as logo marks of broadcasting channels, and so on). A ROM 15 stores therein font data used as EPG text data, and so on.

A limited reception processing section 7 performs the following processes. Conditional access, which is pre-contract type broadcasting. is performed in a unit of service or a unit of program, and objective TS of MPEG 2 is transmitted after being cryptographed. The limited reception processing section 7 is comprised of a cryptanalysis processing section (a descrambler 20) and an IC card 21 on which contract information has been recorded. This IC card 21 is delivered to each receiver user from a service center managed by a community of broadcasting industries. Contract information between a user and a broadcasting industry recorded on this card contains contract conditions indicating possible/impossible of viewing a program, and the contents vary in general from user to user. According to the contract conditions, viewable channels or viewable programs are arranged, e.g., per month or year. When the user choices a conditional access program, the limited reception processing section 7 uses both of the contract conditions and cryptanalysis relation information obtained from the broadcasting wave, and if the user is under the contract, the limited reception processing section 7 cryptanalyzes TS of MPEG 2 so the user can view this program. On the other hand, if the user is not under the contraction, TS of MPEG 2 is not cryptanalyzed so the user can not view this conditional access program. In this case. information indicating that it is impossible to view the program. which is stored in the ROM 15 or the like, is displayed on an EPC display screen.

Besides, in case of pay per view programs, a purchase state is recorded on the IC card 21 every time when the user purchases a program, and information on the purchase of pay per view program is transmitted from the receiver side to the broadcasting delivery industry side via a modem 18 and a public line 19 at regular time intervals.

Instructions inputted by the user with the remote controller 12 are sent to the CPU 17 via an interface 13 and recognized. According to the user's instructions, the CPU 17 controls each component in the receiver 1. For example. it sends a command to the tuner 4 to tune in the channel frequency designated by the user.

When displaying EPG, the CPU 17 makes EPG text data based on SI stored in the RAM 16. Using graphic data such as the frame data for the program guide stored in the flash memory 14, font data in the ROM 15, and the EPG text data, the CPU 17 makes EPG display data and supplies it to the display processor 9. On the basis of a switching command from the CPU 17, the display processor 9 switches between program video data from the video decoder 8 and the EPG display data, or superimposes the EPG display data on the program data and outputs the result to the display 22 as a video signal.

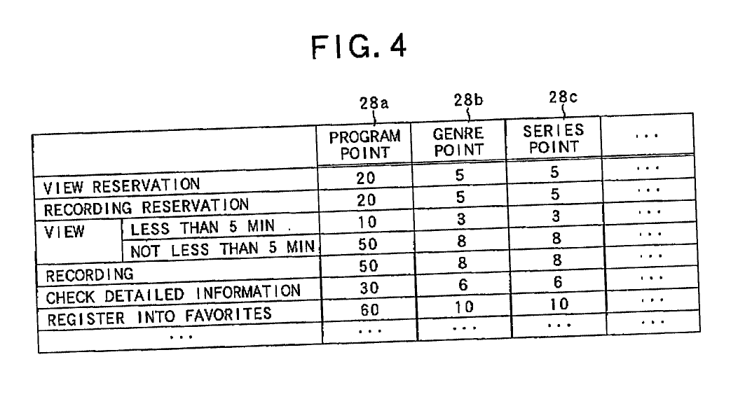

Besides, according to instructions input by the user with the remote controller 12, the CPU 17 calculates a program priority degree to be displayed in EPG, on the basis of SI stored in the RAM 16 and user's operation historics (e.g., histories shown in FIGS. 2, 3A, and 3B). In EPG displayed on the display 22, there is EPG for displaying the program guide on the basis of the program priority degree, which will be referred to as priority EPG hereinafter. The CPU 17 calculates the priority degrees of all programs included in the range displayed in priority EPG, and gives priority over a higher-priority program to display it in priority EPG. Calculation of priority degree is performed on the basis of point data, e.g., as shown in FIG. 4. The point data shown in FIG. 4 is stored in, e.g., the RAM 16. and it can freely be changed by an operator. This point data includes program points 28a, genre points 28b, and series points 28c, which correspond to history per program of FIG. 2, history by genre of FIG. 3A, and history by series of FIG. 3B, respectively.

The bus 2 is connected with the public line 19 through the modem 18 and connects with a telephone or a personal computer in the user's home to make a necessary communication between a broadcasting station and the viewer's home.

By the above-described construction, the receiver 1 has a function as a program guide apparatus according to the present invention.

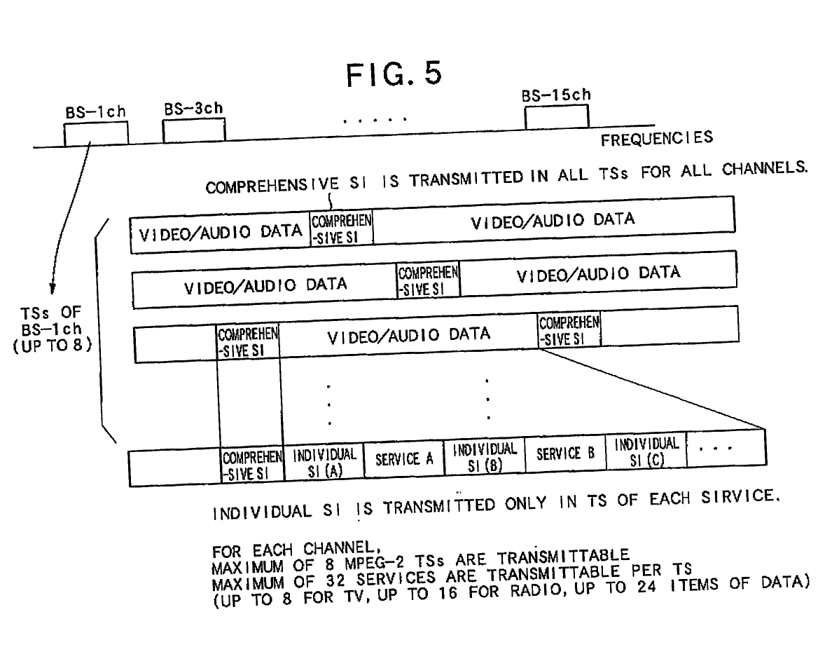

Next, a digital signal transmitted from the satellite as data used as the base of EPG display data will be described. FIG. 5 schematically shows a data form of the digital signal. As shown in FIG. 5, in the satellite digital broadcasting system, a plurality of BS channels (bands) are set and eight TSs of MPEG 2 at the maximum can be transmitted for each BS channel. Besides, 32 services at the maximum can be transmitted by one TS. In the below description, a frequency band in satellite broadcasting is referred to as a BS channel and discriminated from the channel of each broadcasting program received by the receiver 1.

In each TS, all-station SI is multiplexed in information such as video/audio. The all-station SI is SI corresponding to all broadcasting stations and contains program arrangement information corresponding to all channels. In short, all-station SI of the same contents is transmitted with being multiplexed in all TSs of all BS channels. Thereby, even when receiving any channel of any broadcasting station, the viewer can make EPG data corresponding to all channels by acquiring all-station SI contained in TS of the channel. More specifically, the CPU 17 shown in FIG. 1 controls the demultiplexer 6 to acquire all-station SI from TS currently received, and based on this, makes EPC text data.

Besides, the lower part of FIG. 5 shows a form of video/audio data in each TS. Although it was described before that 32 services at the maximum can be transmitted per one TS, those plural services are tine-divisionally multiplexed in a form of packet in one TS In the example shown in FIG. 5, a plurality of broadcasting station services (service A, B. . . . ) are time-divisionally multiplexed in the lowermost TS. Therefore, to receive, e.g., service A, the CPU 17 first makes the tuner 4 of FIG. 1 tune in the BS channel Containing the TS. Next, the demodulation processing section 5 of FIG. 1 specifies and extracts the target TS from a plurality of TSs contained in the BS channel, and further it becomes necessary to extract service A time-divisionally multiplexed in the TS by the demultiplexer 6 with reference to the identification information.

As shown in FIG. 5, in data of each service station (shown by service A, B, . . . ), each-station SI in relation to the service is inserted. Note that, in FIG. 5, for convenience, an example of inserting in the head of data of each service station is shown. Although each-station SI is information similar to all-station SI, it contains information peculiar to each station that is not contained in all-station SI. That is, all-station SI contains information necessary for displaying a program guide in relation to all cannels as EPG, while each-station SI contains, e.g., detailed information on each program. Therefore, by acquiring each-station SI in response to the user's instructions, the CPU 17 of FIG. 1 can display detailed information on a specific program.

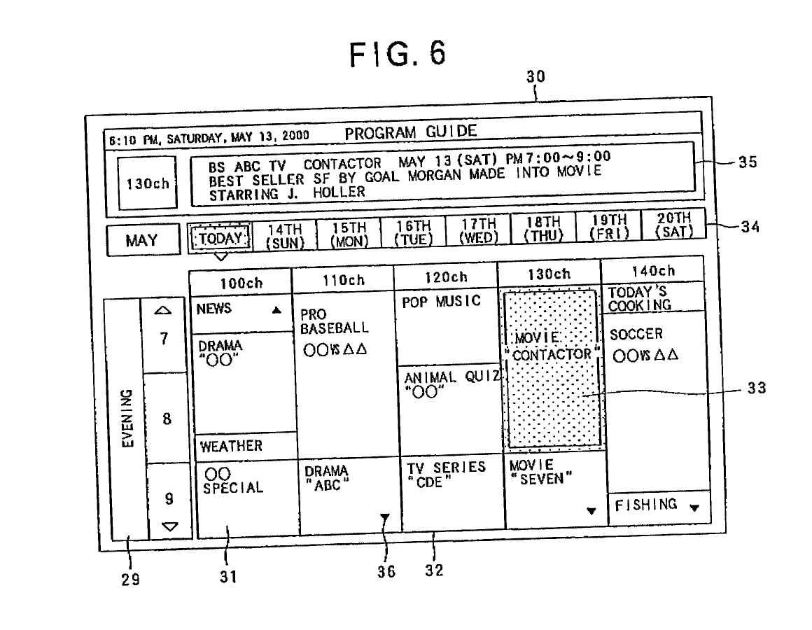

Next, an EPG display screen will be described. FIG. 6 shows an example of fundamental EPG display screen. The EPG display screen shown in FIG. 6 shows a program guide of a plurality of channels on a daily basis (on a day-of-the-week basis), which will be referred to as a day-of-the-week EPG hereinafter. The day of the-week EPG 30 is displayed by pressing an EPG key 91 of the remote controller 12, which will be described later.

In the uppermost part of the day-of-the-week EPG 30. the present date and time are displayed. As shown in FIG. 6, the day-of-the-week EPG 30 has a program guide corresponding to eight days from that day to the same day of the next week. A program guide for all channels is prepared for each day of the week. When the user designates a desired day with a day-of-the-week tab 34, the program list of that day is displayed. The program guide is changed into that of the next week every time when a day-of-the-week change key 92 of the remote controller 12, which will be described later. When reaching the program guide seven days after, then it returns to the today program guide.

The program guide is displayed in a program guide display area 32, and each unit partitioned by a frame is referred to as a program cell 31. On the left side of the program guide display area 32, there is a time zone display area 29. The example of FIG. 6 shows an example in which a program guide of a time zone from 7 p.m. to 10 p.m. of May 13 (Saturday) is displayed. In each program cell 31, the title of a program broadcasted in the time zone displayed in the time zone display area 29, and so on are displayed. Besides, in the upper part of the program guide display area 32, channels are displayed in a lateral direction.

Besides, in a certain program cell 31, a continuation mark 36 is displayed. The continuation mark 36 indicates that, since the program is for a long time, it can not displayed in the present program guide display area 32 and continues in the time axis direction shown by the mark. For example, although a cinema “Seven” started from 9 p.m. of 130 ch in FIG. 6 is a two-hour program, since the time zone is displayed only to 10 p.m. in FIG. 6, all of them can not be displayed. Therefore, the continuation mark 36 indicates that the program continues even after 10 p.m. Besides, an emphasis portion shown by a cursor 33 indicates the program selected by the user at present. Besides, brief information of the program selected at present is displayed in a brief information area 35 in the upper part of FIG. 6. This brief information is generated on the basis of all-station SI in each TS as described above. For the program indicated by this cursor 33, using the remote controller 12, a view reservation, a recording reservation. a view, a recording, a detailed information display, and a registration into favorites can be performed.

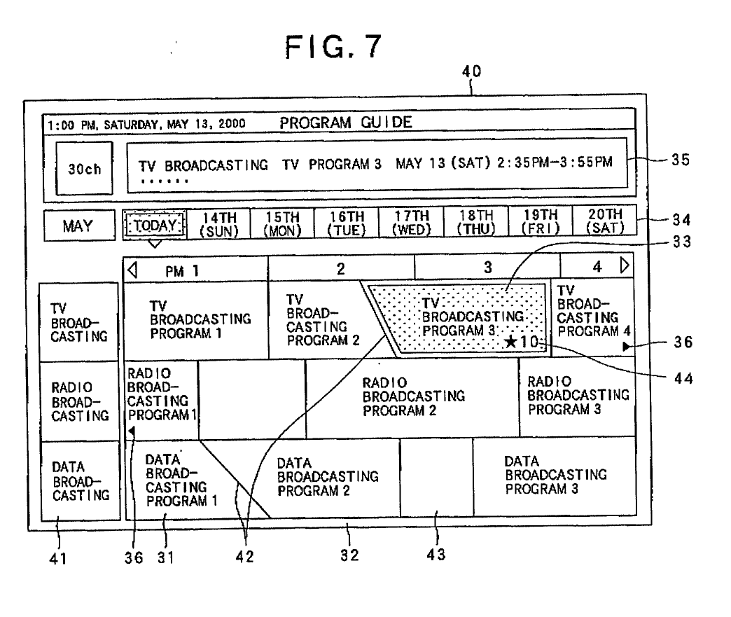

FIG. 7 shows an example of a priority EPG display screen by medium. The priority EPG 40 by medium shown in FIG. 7 preferentially displays a hither-priority program by medium. which is displayed by pressing a schedule key 93 of the remote controller 12, which will be described later. Also in the priority EPG 40, like the day-of-the-week EPG 30, a program guide is displayed in the program guide display area 32. Besides, in the upper part of the program guide display area 32, a time zone is displayed. The example of FIG. 7 shows an example in which a program guide in the time zone from 1:00 p.m. to 4:30 p.m. of May 13 (Saturday) is displayed. Besides, on the vertical axis on the left side of the program guide display area 32, there is a medium type display area 41 in which medium types regulated by the BS digital broadcasting is displayed. In the example of FIG. 7, in the medium type display area 41, a television broadcasting, a radio broadcasting, and a data broadcasting are displayed. In another display portion, e.g., in a day-of-the-week tab 34 or the like, the same contents as those of the day-of-the-week EPG 30 are displayed.

Also in the program guide display area 32 in the priority EPG 40, the title of a program and so on are displayed in the program cell 31. Besides, in the program cell 31 selected by the user at present, the cursor 33 is displayed, and like the day-of-the-week EPG 30, using the remote controller 12. a view reservation, a recording reservation, a view, a recording, a detailed information display, and a registration into favorites can be performed. The program displayed in each program cell 31 is broadcasted by a medium displayed in the medium type display area 41 on the left side of the program, respectively. For example, a title name “television broadcasting program 3” shown in FIG. 7 indicates a program broadcasted by television broadcasting. The programs displayed in these program cells 31 are displayed on the basis of priority degrees as described above. That is by medium, the highest priority program in each time is displayed in the program guide display area 32.

In the example of FIG. 7, since “television broadcasting program 3” performed by television broadcasting has the highest priority degree in the time zone from 2:35 to 3:55, it is displayed on the priority EPG. Therefore, the titles and so on of the other programs (programs whose priority degrees are lower than that of “television broadcasting program 3”) whose broadcasting time zones completely overlap that of “television broadcasting program 3” are not displayed on the priority EPG. However, another program (program whose priority degree is lower than that of “television broadcasting program 3”) whose broadcasting time zone partially overlaps that of “television broadcasting program 3” is displayed on the priority EPG. For example, “television broadcasting program 2” shown in FIG. 7 is a program broadcasted in the time zone from 2:00 to 2:55 and having the highest priority degree in the time zone from 2:00 to 2:35. However, in the time zone from 2:35 to 2:55, it overlaps “television broadcasting program 3” whose priority degree is higher than that of this program. In this case, in the overlapping time zone, as shown by a reference numeral 42 portion, by a slant divisional line, it is displayed so that both broadcasting time zones of “television broadcasting program 2” and “television broadcasting program 3” can be seen. That is, in the example of FIG. 7, by the slant divisional line 42, the user can grasp the start time (2:35) of “television broadcasting program 3” and the end time (2:55) of “television broadcasting program 2”.

Besides, in the priority EPG, only programs more than a predetermined priority degree can be set so that their program titles and so on are displayed. That is, as a result of calculation of priority degree by the CPU 17, as for a program whose priority degree is lower than a predetermined reference priority degree, it can be omitted from the display objects to the priority EPG. This reference priority degree can be arbitrarily set by a user or the like. Besides, in a reference numeral 44 portion of FIG. 7, the number of programs whose broadcasting time zones overlap “television broadcasting program 3” is displayed. Thereby, the user can confirm what number of programs whose priorities are lower than that of “television broadcasting program 3” and higher than the reference priority degree are not displayed. Besides, although anything is not displayed in the program cell shown in a reference numeral 43 portion of FIG. 7, this corresponds to a case wherein there is no program broadcasted in this time zone or a case wherein, although there is a program broadcasted, its priority degree is not more than the reference priority degree.

Besides, a rightward continuation mark 36 shown in FIG. 7 indicates that the time zone of the program continues in the right direction (the direction that the time is later) and a leftward continuation mark 36 indicates that the time zone of the program continues in the left direction (the direction that the time is earlier).

Note that, in the display example of FIG. 7, although the program guide corresponding to three hours and 30 minutes in a time axis direction and three media in a medium type axis direction, the present invention is not limited to this, and for example, it can be constructed so that a longer time or more media are displayed at once.

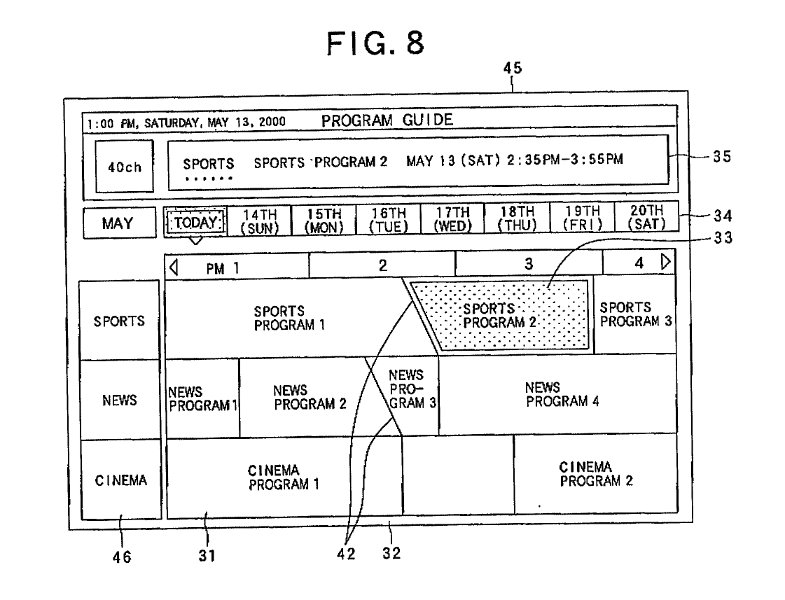

FIG. 8 shows an example of priority EPG display screen by genre. The priority EPG 45 by genre shown in FIG. 8 preferentially displays a hither-priority program by genre, which is displayed by pressing, in a state that the priority EPG 40 shown in FIG. 7 is displayed, a schedule change key 94 of the remote controller 12, which will be described later. Also in the program guide display area 32 of the priority EPG 45 shown in FIG. 8, like the priority EPG 40 shown in FIG. 7, in each time, the highest-priority program is displayed. The point different from the priority EPG 40 is a point that the program guide is divided by a genre type. That is, the vertical axis on the left side of the program guide display area 32 of the priority EPG 45 is a genre type display area 46 displaying genre types, and by genre displayed in this area 46, the highest-priority program in each time is displayed in the program guide display area 32. Note that, in the example of FIG. 8, in the genre type display area 46, sports, news, and cinema are displayed, and by scrolling downward, genres other than those, e.g., drama. variety, and so on are displayed. Besides, various functions in the other priority EPG 45 are the same as in the above-described priority EPG 40.

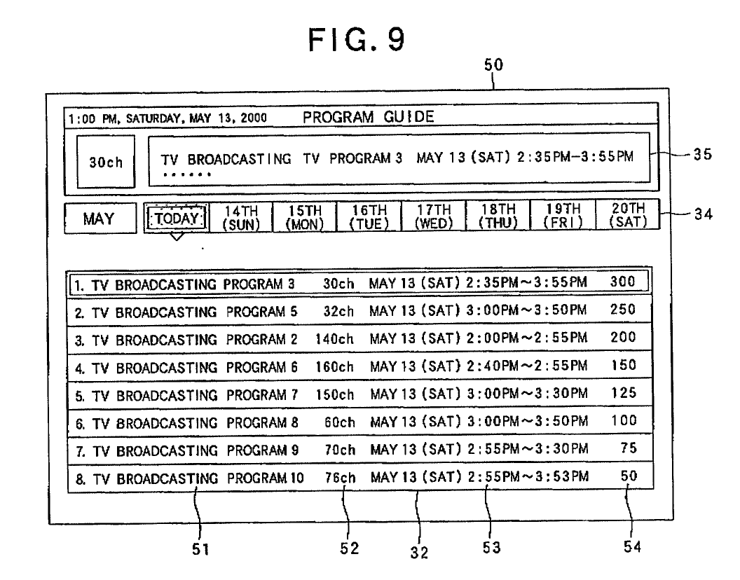

FIG. 9 show an example of EPG display screen displaying information on programs in the order of the priority degree lowering in a certain time zone, which will be referred to as a priority order EPG hereinafter. In the priority order EPG, information on a program whose time zone completely overlaps the highest-priority program and which is not displayed on the priority EPG can be displayed. In a state that the priority EPG is displayed, when an other-program key 95 of the remote controller 12, which will be described later, is pressed, the priority order EPG concerning the time zone of the program cell 31 where the cursor 33 exists is displayed. For example, the priority order EPG 50 shown In FIG. 9 is displayed by, in a state that the cursor 33 is displayed in the program cell of “television broadcasting program 32” shown in FIG. 7. pressing the other-program key 95.

In the example of FIG. 9, in the order of the higher-priority program, the title 51 of the program, the broadcasting channel 52, the broadcasting date 53, and the priority degree 54 are displayed in the form of list in the program guide display area 32. For example, the broadcasting time zone of “television broadcasting program 5” is from 3:00 to 3:50, and since it completely overlaps the broadcasting time zone of “television broadcasting program 3”, though it is not displayed on the priority EPG 40, it is displayed on the priority order EPG 50. Besides, as for “television broadcasting program 2” whose broadcasting time zone partially overlaps “television broadcasting program 3”, it is displayed on the priority order EPG 50. Besides, also on this priority order EPG 50, the selection of a program is possible by the cursor 33, and like the day-of-the-week EPG 30, as for the selected program, a view reservation. a recording reservation, a view. a recording, a detailed information display, and a registration into favorites can be performed.

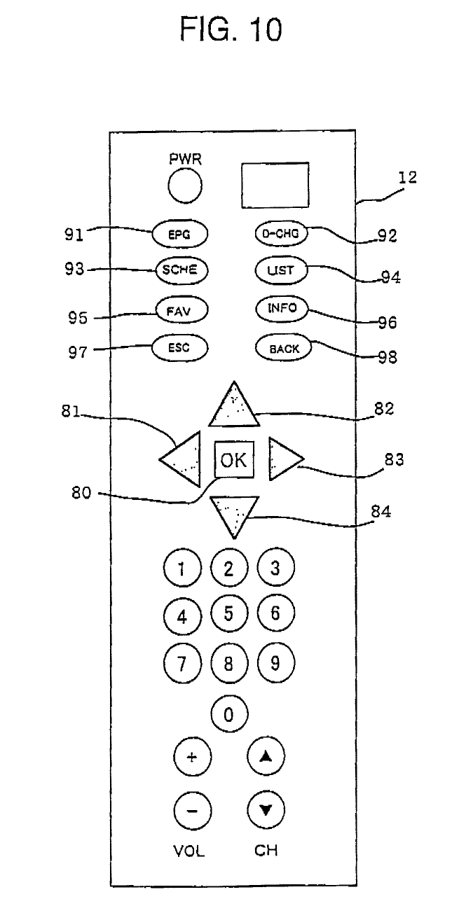

FIG. 10 shows an appearance of the remote controller 12 used in association with the digital receiver 1 of the present invention. Of function keys provided in the upper part of the remote controller 12, an EPG key 91 is a key for displaying a normal day-of-the-week EPG screen. that is, in a state that a normal program is viewed, when the EPG key 91 is pressed. the screen of the display 22 is changed from a program screen into the day-of-the-week EPG screen as shown in FIG. 6. Note that the day-of-the-week EPG screen may be displayed with being superimposed on the program screen. Besides, when the EPG key 91 is pressed in a state that the day-of-the-week EPG screen is displayed, it returns to the original program screen. A key at the right of the EPG key 91 is a day-of-the-week change key 92, which is used for changing a day of the week in the program guide displayed. A key below the EPG key 91 is a schedule key 93, and in a state that the day-of-the-week EPG screen is displayed, when the schedule key 93 is pressed, the screen is changed into the priority EPG screen, e.g., the priority EPG screen as shown in FIG. 7. A key rightward adjacent to the schedule key 93 is a schedule change key 94, and in a state that the priority EPG screen is displayed, when the schedule change key 94 is pressed, the screen is changed into another priority EPG screen, e.g., the priority EPG screen as shown in FIG. 8. A key below the schedule key 93 is an other-program key 95, and in a state that the priority EPG screen is displayed, when the other-program key 95 is pressed, the screen is changed into the priority order EPG screen, e.g., the priority order screen as shown in FIG. 9.

Besides, a key rightward adjacent to the other-program key 95 is a detailed information key 96, and in a state that the day-of-the-week EPG screen, or the priority EPG screen. or the priority order EPG screen is displayed, or in a state that a program is viewed, when the detailed information key 96 is pressed, a detailed information display EPG of the program selected by the cursor 33 is displayed. In the detailed information display EPG (not shown), detailed information on the program selected by the cursor 33 is displayed. For example, together with information displayed in the brief information area 35 in the upper part of each EPG screen, detailed contents of the program (e.g., an outline), information indicating whether or not it is a program of limited broadcasting, information indicating that it can not be viewed because of contract conditions, and so on are displayed. This program detailed information is generated based on each-station SI in each TS as described above. Besides, the program detailed information EPG is in one-to-one correspondence with all program cells 31 displayed in each EPG, and provided by program. Besides, by pressing the detailed information key 96, It is determined that in the above-described history by program. history by genre, and history by series, a detailed information is confirmed, so that detailed information is updated.

Besides. a key below the other-program key 95 is a favorite key 97. and when the favorite key 97 is pressed, the screen is changed into a screen (not shown) for registering a program. genre, series, or the like favorite by the user. In this screen, information such as registered program, genre, series, or the like is updated in the above-described history by program, history by genre, and history by series, since It is determined that the information is registered into favorites. For example, in a state that the priority EPG screen of FIG. 7 is displayed, or in a state that a program is viewed, when the favorite key 97 is pressed. the screen is changed into a favorite registration screen of “television broadcasting program 3” where the cursor 33 exists. In this screen, if “television broadcasting program 3” is registered into favorites, “1” is stored in the area corresponding to the area “registration into favorites” in the history by program of “television broadcasting program 3”, the history by genre of the genre of “television broadcasting program 3”, and the history by series of the series of “television broadcasting program 3”.

Besides, a BACK key 98 rightward adjacent to the favorite key 97 is used for canceling a command input before and returning to the state before the command. Besides, an ESC key 99 below the favorite key 97 is used for returning from the EPG screen to the program screen.

Besides, cursor movement keys 81 to 84 are disposed substantially at the center of the remote controller 12, which are used for moving the position of the cursor 33 in each EPG screen. For example, in a display state of the EPG screen, when the leftward key 81 is pressed, the cursor 33 moves to the leftward adjacent program cell, and when the rightward key 83 is pressed, the cursor moves to the rightward adjacent program cell. Besides, when the upward key 82 is pressed, the cursor 33 moves upward, and when the downward key 84 is pressed, the cursor 33 moves downward.

However, in a state that the cursor 33 is only moved by operating the cursor movement keys 81 to 84, on processing of the receiver 1, the selection of the program is not yet determined. After the cursor 33 moves, by pressing a determination key 80, the selection of the program is determined. For example, when the cursor 33 is moved to the program cell broadcasted at present by the cursor movement keys 81 to 84 and the determination key 80 is pressed, the receiver 1 switches to the channel of the program and outputs the video and audio of the program to the display 22 or the like. Besides, by pressing this determination key 80, on the screen, together with the video of the program, a program recording screen appears. By performing operations instructed by this program recording screen, a recording of the program can be made. In this way, the user can view and record the program. Besides, the fact that this view and recording are performed, as described above, is reflected on the history by program, history by genre, and history by series. Besides. in this embodiment, the CPU 17 counts the view time, and as described above, the fact whether or not view is made for five minutes or more, is also reflected on the history by program, history by genre, and history by series.

Besides, if the cursor 33 is moved to the program cell scheduled to be broadcasted for future by the cursor movement keys 81 to 84 and the determination key 80 is pressed, a reservation screen of the program appears. By performing operations instructed by the reservation screen, a view reservation and a recording reservation of the program can be made. The fact that this view reservation and recording reservation are performed, as described above, is also reflected on the history by program, history by genre, and history by series.

Note that the other keys in the remote controller 12 of FIG. 10 relates to normal TV reception and so on, and since they have no particular direct connection with the present invention, the description thereof is omitted.

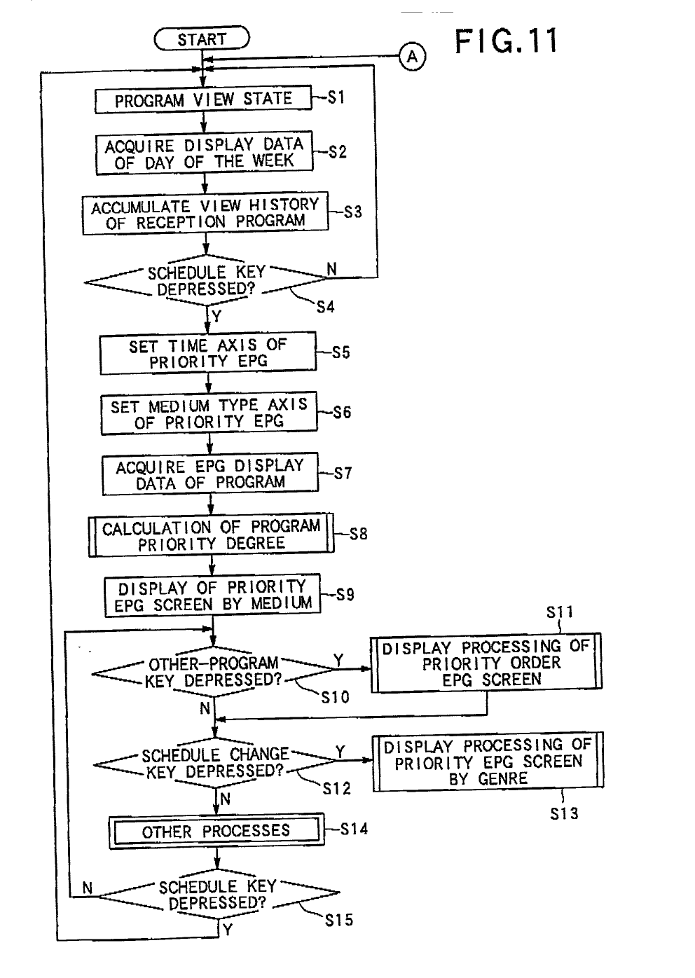

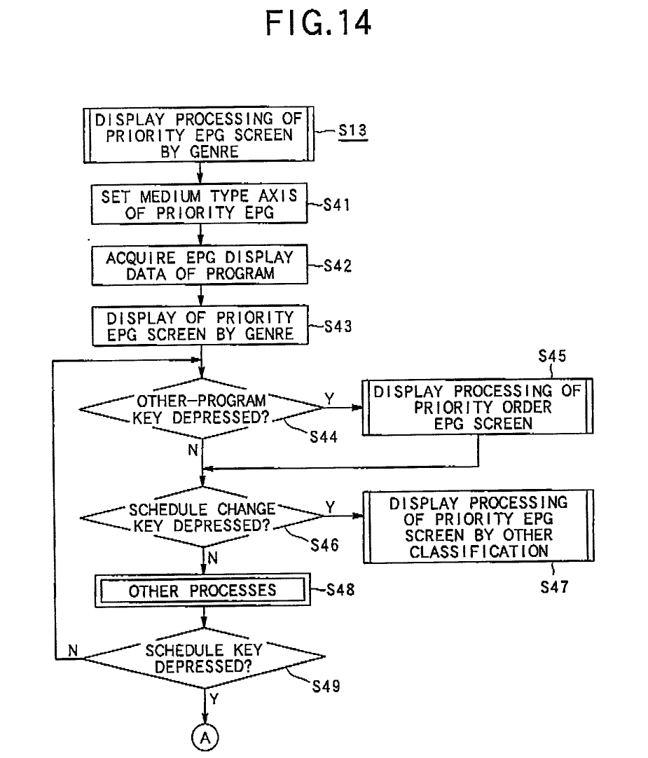

Next, display processing of the priority SPC will be described with reference to the flowcharts of FIGS. 11 and 14. Note that the processes described below are performed by the CPU 17 executing a predetermined program stored in the ROM 15 with controlling the RAM 16, the display processor 9. and so on.

FIG. 11 shows the main routine of priority EPO display processing. Now assume that a user controls the receiver 1, receives a desired channel, and in a state of viewing a program (step SI). In this state, the CPU 17 counts a reception continuation time of the program received (viewed) at present (hereinafter referred to as reception program).

First, the CPU 17 extracts all-station SI from TS of the channel being received, and acquires date data contained therein. Next, from the acquired date data, it specifies the date and a day of the week of that day of view, and on the basis of those data, as data of a day-of-the-week cell of EPG, acquires EPG display data corresponding to eight days from that day (step S2).

Next, the CPU 17 acquires, from the extracted all-station SI, information on the reception program, e.g., information such as the title of the program, an identification code peculiar to the program, a genre of the program, a series number of the program, and so on. And, the CPU 17 accumulates view histories in relation to that program by program, by genre, and by series (step S3). For example, in case that the reception continuation time of the program elapses five minutes, the CPU 17 stores “1” in a storage area of RAM 16 corresponding to the title (identification code) of the reception program in the operation item “view not less than five minutes” of the history by program shown in FIG. 2. Besides, In the operation item “view not less than five minutes” of the history by genre shown in FIG. 3A, “1” is stored in a storage area of the RAM 16 corresponding to the genre of the reception program acquired from all-station SI. Besides, in the operation item “view not less than five minutes” of the history by series shown in FIG. 3B, “1” is stored in a storage area of the RAM 16 corresponding to the series of the reception program acquired from all-station SI. Such an accumulation of the view histories is performed every time when the user controls the receiver 1 and switches the channel.

Next, in case that the schedule key 93 is depressed by the user, the CPU 17 detects this (step S4), and sets a time axis in the upper part of the program guide display area 32 of the priority EPG by medium to be displayed (step S5). This is performed by the manner that the display head time of the left end portion of the time axis is set to the head of a unit time including the present time. Next, the CPU 17 sets a medium type axis in the medium type display area 41 of the priority EPG by medium to be displayed (step S6). Next, the CPU 17 determines a display range in the program guide display area 32. and acquires the EPG display data of the program corresponding to the range from all-station SI (step S7). In that EPG display data, for example, the program title, the broadcasting channel, the identification code, the genre, the series number, the broadcasting time zone, brief information, and so on are contained. For example, assuming that the size of the program guide displayable at once by setting of the receiver 1 corresponds to m hours in a time axis direction and n media in a medium type axis direction, it determines a display range corresponding to m hours from the display head time set in step S5 and n media from the display head medium set in step S6, and acquires EPG display data of the program corresponding to the range.

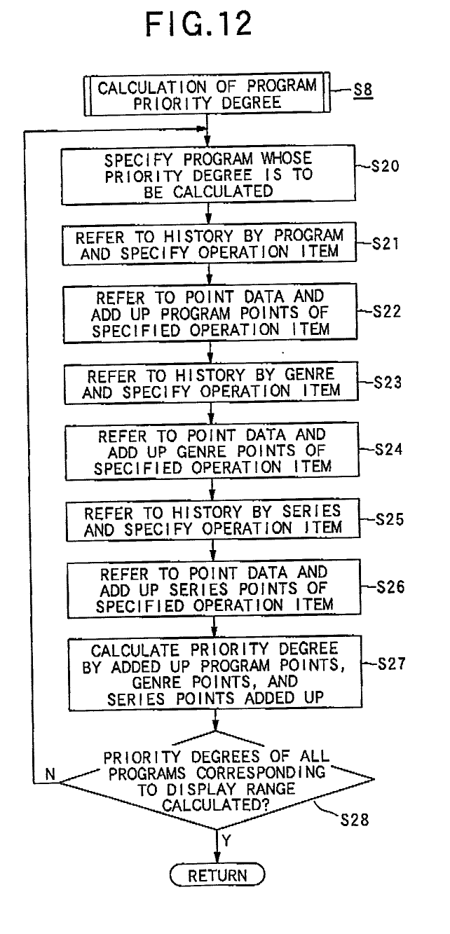

Next, on the basis of the EPG display data of the program acquired in step S7 and user's operation histories (FIGS. 2, 3A, and 38) stored in the RAM 16, the CPU 17 starts a calculation of the priority degree of the program corresponding to the display range (step S8). FIG. 12 shows a subroutine of calculation processing of priority degree in step S8 of FIG. 11.

First, the CPU 17 specifies a program as a calculation target of the priority degree (step S20). Assuming that “program 1” is specified, as shown in FIG. 12. the CPU 17 refers to the history by program (see FIG. 2) stored In the RAM 16, and specifies operation items in which “1” is stored in the item (storage area) corresponding to “program 1” (in the example of FIG. 2. “view reservation”, “view not less than five minutes”, and “recording”) (step s21). Next, of point data (see FIG. 4) stored in RAM 16, the CPU 17 refers to the program points 28a, acquires the program points corresponding to the operation items specified in step S21, and adds up (in the example of FIG. 4, added-up program points=20 points+50 points+50 points=120 points) (step S22).

Next, the CPU 17 refers to the history by genre (see FIG. 3A) and specifies operation items in which “1” is stored in the item (storage area) corresponding to the genre (here, assuming sports) of “program 1” obtained from the EPG display data (in the example of FIG. 3A, “view reservation” and “detailed information check”) (step 523). Next, of the point data (see FIG. 4), the CPU 17 refers to the genre points 25b, acquires the genre points corresponding to the operation items specified In step 823. and adds up (in the example of FIG. 3A, added-up genre points=5 points+6 points=11 points) (step S24).

Next, the CPU 17 refers to the history by series (see FIG. 3B) and specifies operation items in which “1” is stored in the item (storage area) corresponding to the series number (here, assuming No. 001) of “program 1” obtained from the EPG display data (in the example of FIG. 3B, “view reservation” and “registration into favorites”) (step S25). Next, of the point data (see FIG. 4), the CPU 17 refers to the series points 28c, acquires the genre points corresponding to the operation items specified in step S25, and adds up (in the example of FIG. 3B, added-up genre points=5 points+10 points=15 points) (step S26). And, the CPU 17 adds up the program points, the genre points, and the series points added up in steps S22, S24. and S26 (the priority degree=120 points+11 points+15 points=146 points), and obtains the priority degree of “program 1” (step S27). In this way, the priority degree of a certain program increases in accordance with some user's operation in connection with the program.

Next, the CPU 17 judges as to whether or not the priority degrees of all programs corresponding to the display range have been calculated (step S28), and if the priority degrees of all programs have not been calculated, specifies a program whose priority degree is to be calculated next, and in relation to the program, performs processing from step S21 to S27 and calculates the priority degree. On the other hand, in step S28, in case that it is judged that the priority degrees of all programs have been calculated, it returns to the main routine shown in FIG. 11.

In step S9 shown in FIG. 11. on the basis of the priority degree of each program calculated, by medium, the CPU 17 and the display processor 9 makes a program guide, and display the priority EPG by medium on the display 22. That is, in each time zone, the highest-priority program is preferential and EPG display data of the program is displayed in the program guide display area 32.

In this way, the priority EPG 40 per medium as shown in FIG. 7 is displayed. In this manner. of many programs, since a program highly possible to be desired by the user is automatically selected and information on the program can be displayed, the time and labor for the user looking for the desired program can be reduced.

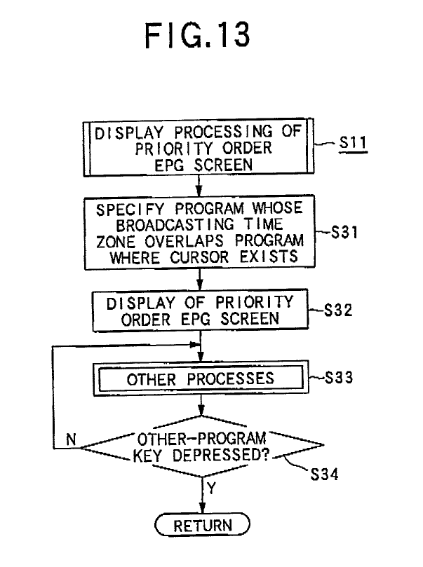

Next, if the user operates the cursor movement keys 81 to 84 of the remote controller 12, moves the cursor 33 onto the desired program cell 31, and depresses the other-program key 95, the CPU 17 detects this (step S10), and shifts to display processing of the priority order EPG (FIG. 13) (step S11).

Besides, If the user depresses the schedule change key 94, the CPU 17 detects this (step S12), and shifts to display processing of the priority order EPG per genre (FIG. 14) (step S13).

Besides, in the other processes of step S14, for example, the user depresses the detailed information key 96 to display the detailed information EPG of a program cell 31 where the cursor 33 exists, or depresses the favorite key 97 to register the program of a program cell 33 where the cursor 33 exists, into favorites. Besides, the user can depress the determination key 80 to perform a recording of a program where the cursor 33 exists, a view reservation, a recording reservation, or the like. As described above, the operation histories performed in the other processes of step S14 are accumulated in the RAM 16 as the history by program. the history by genre, and the history by series.

Note that, though not shown, as described above, the other processes of step 614 are received not in displaying the above-described various EPG screens but in viewing the program.

Besides, if the user again depresses the schedule key 93, the CPU 17 detects this (step S11) and returns to the program view state.

Next, display processing of the priority order EPG in step S11 of FIG. 11 will be described. FIG. 13 shows a flowchart of display processing of that priority order EPG. In the display process of the priority order EPG shown in FIG. 13, first, the CPU 17 specifies a program whose broadcasting time zone overlaps the program of the program cell 31 where the cursor 33 exists (step S31). And, on the basis of the priority degree calculated in step SB, in the order of the higher priority of the specified program, program information is arranged and a list is made, and it is displayed on the display 22 as the priority order EPG (step S32).

In this way, the priority order EPG 50 as shown in FIG. 9 is displayed. In this manner, in the priority order EPG 50, information on the program whose broadcasting time zone completely overlaps the program displayed on the priority EPG 40 and which is not displayed can be also seen.

In the other processes of step S33, the same processes as in the above step S14 can be performed. Besides, the operation histories performed in the other processes of step S33 are also accumulated in the RAM 16 as the history by program, the history by genre, and the history by series. And, if the user again depresses the other program key 95, the CPU 17 detects this (step S34) and returns to the main routine of FIG. 11.

Next, display processing of the priority EPG per genre in step S13 of FIG. 11 will be described. FIG. 14 shows a flowchart of display processing of that priority EPG by genre. In the display process of the priority EPG by genre shown in FIG. 14, first, a genre type axis in the genre type display area 46 of the priority EPG by genre to be displayed is set (step S41). Next, a display range of the program guide in the program guide display area 32 is determined and EPG display data of the program corresponding to the range is acquired from all-station SI (step S42).

Next, the CPU 17 and the display processor 9 make a program guide based on the priority degree of each program calculated in step S8, by genre, and display the priority EPG by genre on the display 22 (step S43). In this way, the priority EPG 45 by genre as shown in FIG. 8 is displayed. The arrangement of genre types and displays displayed here can be arbitrary set by the user. Note that, in the display process of the priority EPG 45 by genre, again, the calculation of the priority degree may be performed (e.g., after step S42).

The processes of the subsequent steps S44 to S49 is the same as those of steps S10 to S15 of display processing of the priority EPG by medium, so the detailed description thereof is omitted.

Note that, by user's operation of the remote controller 12, in case that the cursor 33 moves out of the above display range, again, the calculation of the priority degree is performed, and the priority EPG or the priority order EPG is displayed.

Besides, the calculation of the priority degree in step S8 may be performed, e.g., before step S4. In this case, the priority degree Is calculated in relation to a predetermined time range including the display range of the priority EPG.

As described above. according to the satellite digital broadcasting receiver 1 according to this embodiment, of many programs receivable, a program highly possible to be desired by the user can automatically be selected and displayed on the basis of the user's operation histories, and the user can easily look for the desired program, so the time and labor for looking for the program can be reduced.

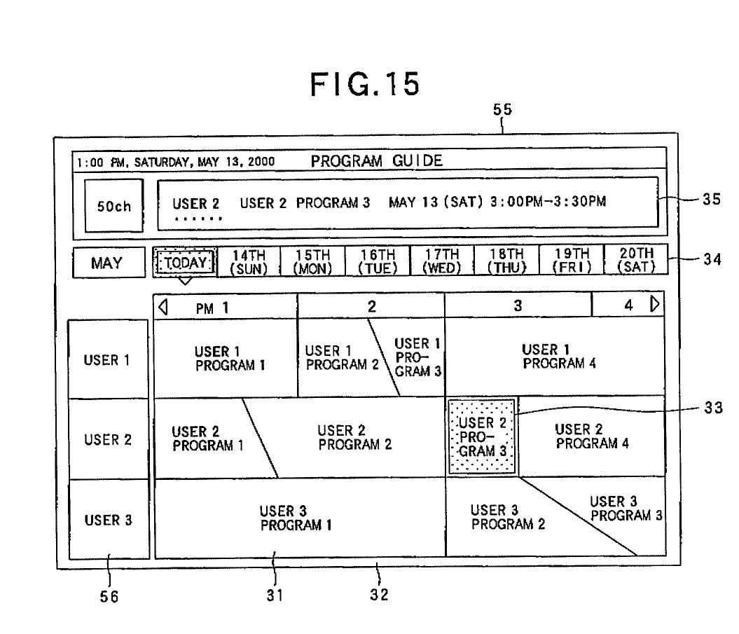

Note that, although, in the type axis (the vertical axis on the left side of the program guide display area 32) of the priority EPG in the above embodiment, it is divided into a medium type and a genre type, the present invention is not limited to this. For example, FIG. 15 shows an example of display screen of the priority EPG by user. Also in the program guide display area 32 of the priority EPG 55 shown in FIG. 15. like the priority EPG 40 shown in FIG. 7, the priority degree of the program corresponding to the display range of EPG is calculated, and in each time zone, the highest-priority program is displayed. The point different from the priority EPG 40 is a point in which the program guide is divided by user. That is, the vertical axis on the left side of the program guide display area 32 of the priority EPG 55 is a display area 56 by user displaying user names, and by user displayed in this area 56, in each time, the highest-priority program is displayed in the program guide display area 32.

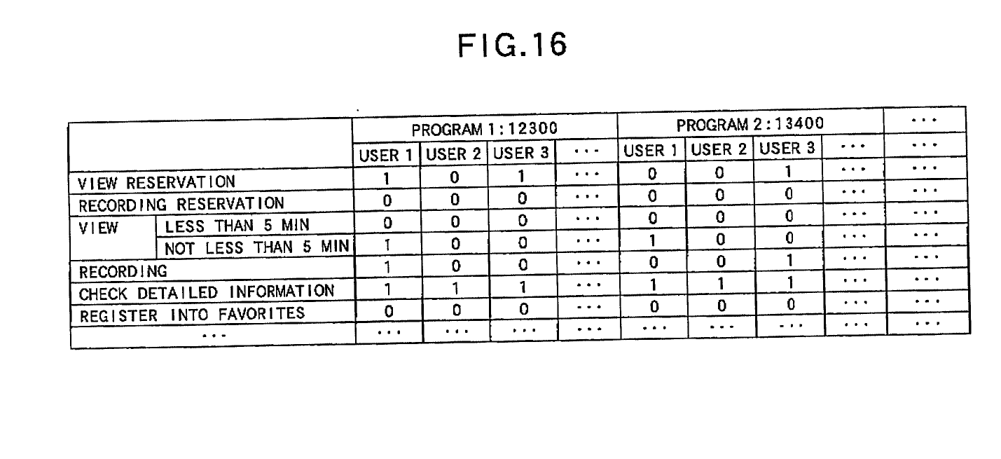

The priority EPG 55 by user is made based on the history by program by user. FIG. 16 shows an example of history by program by user stored in the RAM 16. The history by program by user shown in FIG. 16 is that the history by program shown in FIG. 2 is developed. in which operation histories of a plurality of users are managed by program. This history by program by user can be made by, e.g., providing the remote controller 12 by user.

That is, peculiar identification codes are given to the respective remote controllers 12, and the identification code is sent with instructions input by the user using the remote controller 12 to the CPU 17 via the interface 13. In the CPU 17, by the identification code sent from the user, it is recognized which user's operation and the fact is reflected on the history by program by user. Note that, although not shown, like the history by program shown in FIG. 2, as for the history by genre shown in FIG. 3A and the history by series shown in FIG. 3B, they are managed by user. Besides, even in case of one remote controller 12, for example, an identification code corresponding to each user is stored in advance in the RAM 16, and when operating the remote controller 12, by the user inputting the identification code, in the CPU 17, by the identification code sent from the remote controller 12, it is recognized which user's operation and it may be reflected on the history by program by user. Besides, by user, it may be constructed so that the priority EPG of FIGS. 7 and 8 may be made and displayed.

Further, it may be constructed so that the priority EPG of a broadcasting network type such as BS digital broadcasting, CS digital broadcasting, and ground wave broadcasting, the priority EPG of a broadcasting station (service industry) type, or the like is displayed.

Besides, in the above embodiment, in FIG. 7, although the vertical axis is medium type and the horizontal axis is time, it may be reversed and the display form is not limited. Also, in FIG. 8, although the vertical axis is genre type and the horizontal axis is time, it may be reversed and the display form is not limited. Also, in FIG. 15, although the vertical axis is user and the horizontal axis is time, it may be reversed and the display form is not limited.

Besides, in the above embodiment, for convenience' sake, although genre is described that one genre is given to one program, in case that a plurality of genres (main genres) are given to one program, and further in case that a plurality of sub-genres are given to one main genre. the genre points of the respective genres are added up and may be used in calculation of the priority degree. or the genre points of only the head main genre may be used in calculation of the priority degree.

Besides, in this embodiment, although an example of program of satellite broadcasting has been described, the present invention is not limited to this and applicable also to a system in which a program is broadcasted by an exclusive cable, and a system in which a program is broadcasted using a public line. e.g., Internet. Besides, in this embodiment, although the EPG screen is displayed on the display 22, the present invention is not limited to this and it may be displayed on a personal computer or the like.

As described above, according to the present invention, since the user can easily and simply look out a desired program on the EPG display screen, the time and labor for looking for the program on the EPG display screen can be reduced.

The invention may be embodied in other specific forms without departing from the spirit or essential characteristics thereof. The present embodiments are therefore to be considered in all respects as illustrative and not restrictive, the scope of the invention being indicated by the appended claims rather than by the forgoing description and all changes which come within the meaning and range of equivalency of the claims are therefore intended to be embraces therein.

The entire disclosure of Japanese Patent Application No. 2000-283208 filed on Sep. 19, 2000 including the specification, claims, drawings and summary is incorporated herein by reference in its entirety.

What is claimed is:

1. A program guide apparatus for displaying information about a broadcast program on a program guide display, comprising:
a priority degree calculating device for calculating priority degrees of programs; and
a display device for, on the basis of the calculated priority degrees of said programs, arranging and displaying program cells of the programs on a program guide display screen of a predetermined time range.

2. A program guide apparatus for displaying information about a broadcast program on a program guide display, comprising:
a priority degree calculating device for calculating priority degrees of programs; and
a display device for, in the order of the calculated priority degrees, arranging and displaying program cells of the programs on a program guide display screen of a predetermined time range.

3. The apparatus according to claim 1, wherein said display device displays visibly said programs which overlap one another in time.

4. The apparatus according to claim 1, further comprising a list display device for displaying a list of programs which overlap a program cell selected by a user in time.

5. The apparatus according to claim 1, wherein said display device displays a classification axis, which is provided in a different direction from a time axis in said program guide display screen, and by each classification in said classification axis, arranges and displays said program cells on the program guide display screen of the predetermined time range.

6. The apparatus according to claim 1, wherein said priority degree calculating device calculates the priority degrees of said programs on the basis of a predetermined operation history of a user.

7. The apparatus according to claim 1, wherein said priority degree calculating device calculates the priority degrees of said programs on the basis of at least one or a combination of a view history, a recording history, a view reservation history, a recording reservation history, a detailed information utilization history. and a user's favorites registration history of a user.

8. The apparatus according to claim 1, wherein said display device determines the program cells to be arranged and displayed on said program guide display screen on the basis of a relative relation among the priority degrees of a plurality of programs.

9. The apparatus according to claim 1, wherein said display device determines the program cells to be arranged and displayed on said program guide display screen on the basis of a relation with a reference priority degree provided in advance.

10. The apparatus according to claim 9, wherein said reference priority degree can be arbitrarily set.

11. The apparatus according to claim 5, wherein said classification is a genre of program.

12. The apparatus according to claim 5, wherein said classification is broadcasting medium of said programs.

13. The apparatus according to claim 5, wherein said classification is user of the program guide apparatus.

14. A program guide method of displaying information about a broadcast program on a program guide display, comprising the processes of:
calculating priority degrees of programs; and
arranging and displaying program cells of the programs on the program guide display screen of a predetermined time range wherein the program whose priority degree is higher should be preferentially displayed.
